(19) United States
(12) Patent Application Publication
(10) Pub. No.: US 2024/0069384 A1
(43) Pub. Date: Feb. 29, 2024

(54) BACKLIGHT UNIT AND DISPLAY APPARATUS HAVING THE SAME

(71) Applicant: SAMSUNG ELECTRONICS CO., LTD., Suwon-si (KR)

(72) Inventors: Sungpil CHOI, Suwon-si (KR); Yeonkyun PARK, Suwon-si (KR); Yonghwan PARK, Suwon-si (KR); Chulho SON, Suwon-si (KR); Kilhong LEE, Suwon-si (KR); Byoungjin CHO, Suwon-si (KR)

(73) Assignee: SAMSUNG ELECTRONICS CO., LTD., Suwon-si (KR)

(21) Appl. No.: 18/211,860

(22) Filed: Jun. 20, 2023

Related U.S. Application Data
(63) Continuation of application No. PCT/KR2023/007256, filed on May 26, 2023.

(30) Foreign Application Priority Data
Aug. 26, 2022 (KR) 10-2022-0107972

(51) Int. Cl. G02F 1/13357

(52) U.S. Cl. CPC G02F 1/133611; G02F 1/133603; G02F 1/133605; G02F 1/133606

(57) ABSTRACT

A backlight unit includes a light source module including a plurality of light sources, a reflection sheet configured to reflect light emitted rearward from the plurality of light sources, and a diffuser plate provided in front of the light source module, where the diffuser plate includes at least two regions having different distances to the plurality of light sources, wherein a first gloss of a first region of the at least two regions and a second gloss of a second region of the at least two regions are different from each other.

### CROSS-REFERENCE TO RELATED APPLICATIONS

This application is a continuation of International Application No. PCT/KR2023/007256, filed on May 26, 2023, in the Korean Intellectual Property Receiving Office, which is based on and claims priority to Korean Patent Application No. 10-2022-0107972, filed on Aug. 26, 2022, in the Korean Intellectual Property Office, the disclosures of which are incorporated herein by reference in their entireties.

### BACKGROUND

### 1. Field

The disclosure relates to a direct type backlight unit with light sources arranged behind a display panel and display apparatus having the backlight unit.

### 2. Description of Related Art

A display apparatus may refer to an output device for visually presenting data information and images, such as text or figures, including a television, various kinds of monitors, many different kinds of portable terminals (e.g., notebooks, tablet personal computers (PCs), and smart phones), etc.

The display apparatus may be classified as a self-luminous display apparatus that utilizes a self-emissive display panel, such as organic light emitting diodes (OLEDs), and as a non-luminous display apparatus that utilizes a display panel requiring to receive light from a backlight unit, such as a liquid crystal display (LCD).

The backlight unit may be classified according to the position of a light source as a direct type backlight unit with the light source positioned behind the display panel and an edge type backlight unit with the light source positioned along the edges of the display panel.

The direct type backlight unit may include a light source module having a plurality of light emitting diodes mounted on a printed circuit board.

Depending on the layout of a light source, a bright region and a dark region may be mixed on a display apparatus, which hinders uniformity of image quality. Furthermore, due to the reduced thickness of display apparatuses, a phenomenon referred to as a lens mura may occur, where the lens protecting a light source may become visually perceptible.

### SUMMARY

Provided are backlight and the display apparatus including the same where uniformity of image quality may be enhanced by adjusting a gloss of the diffuser plate included in the backlight unit.

Additional aspects will be set forth in part in the description which follows and, in part, will be apparent from the description, or may be learned by practice of the presented embodiments.

According to an aspect of the disclosure, a backlight unit may include a light source module including a plurality of light sources, a reflection sheet configured to reflect light emitted rearward from the plurality of light sources, and a diffuser plate provided in front of the light source module, where the diffuser plate may include at least two regions having different distances to the plurality of light sources, wherein a first gloss of a first region of the at least two regions and a second gloss of a second region of the at least two regions are different from each other.

The first region may be at a first distance from the plurality of light sources, the second region may be at a second distance to the plurality of light sources that is greater than the first distance, and the second gloss of the second region may be higher than the first gloss of the first region.

The at least one first region may include an area on the diffuser plate facing the plurality of light sources, and the at least one second region may include an edge area on the diffuser plate enclosing the at least one first region.

A border between the first region and the second region may be determined based on positions of outermost light sources among the plurality of light sources.

The light source module may include a plurality of substrates having a bar shape and the plurality of light sources may be provided on the plurality of substrates.

The at least one first region may include a plurality of sub-regions in the diffuser plate corresponding to the plurality of substrates and the second region may include an area of the diffuser plate not corresponding to the plurality of sub-regions.

The first gloss of the first region may be between 5 gloss units (GU) to 10 GU and the second gloss of the second region may be between about 20 GU to about 30 GU.

The first region may have a first roughness that is higher than a second roughness of the second region.

A first thickness of the diffuser plate at a first location corresponding of the first region may be larger than a second thickness of the diffuser plate at a second location corresponding to the second region.

The at least two regions having different gloss may be provided on a rear surface of the diffuser plate.

According to an aspect of the disclosure, a display apparatus may include a liquid crystal panel, and a backlight unit provided behind the liquid crystal panel and configured to supply light to the liquid crystal panel, where the backlight unit may include a light source module including a plurality of light sources, a reflection sheet configured to reflect light emitted rearward from the plurality of light sources, and a diffuser plate provided in front of the light source module, where the diffuser plate may include at least two regions having different distances to the plurality of light sources, wherein a first gloss of a first region of the at least two regions and a second gloss of a second region of the at least two regions are different from each other.

The first region may be at a first distance from the plurality of light sources, the second region may be at a second distance from the plurality of light sources that is greater than the first distance, and the second gloss of the second region is may be higher than the first gloss of the first region.

The first region may include an area on the diffuser plate facing the plurality of light sources, and the second region may include an edge area on the diffuser plate enclosing the first region.

A border between the first region and the second region may be determined based on positions of outermost light sources among the plurality of light sources.

The light source module may include a plurality of substrates having a bar shape, and the plurality of light sources may be provided on the plurality of substrates.

The first region may include a plurality of sub-regions in the diffuser plate corresponding to the plurality of substrates, and the second region may include an area of the diffuser plate not corresponding to the plurality of sub-regions.

The first gloss of the at least one first region may be between 5 GU to 10 GU, and the second gloss of the at least one second region may be between 20 GU to 30 GU.

The first region may have a first roughness that is higher than a second roughness of the second region.

A first thickness of the diffuser plate at a first location corresponding to the first region may be larger than a second thickness of the diffuser plate at a second location corresponding to the second region.

The at least two regions having different gloss may be provided on a rear surface of the diffuser plate.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram of an example of an exterior of a display apparatus, according to an embodiment;

FIG. 2 is diagram of an example of a structure of a display apparatus, according to an embodiment;

FIG. 3 is a cross-sectional view of an example of a liquid crystal panel included in a display apparatus, according to an embodiment;

FIGS. 4 and 5 are diagrams of a backlight unit, according to an embodiment;

FIG. 6 is a cross-sectional view of gloss of a diffuser plate depending on the position of a light source in a backlight unit, according to an embodiment;

FIG. 7 is a diagram of gloss of a diffuser plate depending on the position of a light source in a backlight unit, according to an embodiment;

FIG. 8 is cross-sectional view of gloss of a diffuser plate depending on the position of a light source in a backlight unit, according to an embodiment;

FIG. 9 is illustrating diagram of a gloss of a diffuser plate depending on the position of a light source in a backlight unit, according to an embodiment;

FIG. 10 is a table representing references of gloss applied to experiments of a backlight unit, according to an embodiment;

FIG. 11 is a table representing results of experiments on a diffuser plate of a backlight unit, according to an embodiment; and

FIGS. 12 and 13 are cross-sectional views of a backlight unit, according to an embodiment.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms. It is to be understood that singular forms include plural referents unless the context clearly dictates otherwise. The terms including technical or scientific terms used in the disclosure may have the same meanings as generally understood by those skilled in the art.

The terminology used herein is for the purpose of describing particular embodiments only and is not intended to limit the disclosure. It is to be understood that the singular forms “a,” “an,” and “the” include plural references unless the context clearly dictates otherwise.

It will be further understood that the terms “include”, “comprise” and/or “have” when used in this specification, specify the presence of stated features, integers, steps, operations, elements, and/or components, but do not preclude the presence or addition of one or more other features, integers, steps, operations, elements, components, and/or groups thereof.

Furthermore, the terms, such as “— part”, “— block”, “— member”, “— module”, etc., may refer to a unit of handling at least one function or operation. For example, the terms may refer to at least one process handled by hardware such as field-programmable gate array (FPGA)/application specific integrated circuit (ASIC), etc., software stored in a memory, or at least one processor.

Ordinal numbers such as “first”, “second”, and the like used before elements to be described in the specification are used to differentiate the elements, but mean nothing to connection sequence, use sequence, priorities, etc., between the elements.

Reference numerals used for method steps are just used to identify the respective steps, but not to limit an order of the steps. Thus, unless the context clearly dictates otherwise, the written order may also be practiced otherwise.

The expression “at least one” as herein used to mention a list of elements may refer to a variable combination of the elements. For example, the expression “at least one of a, b or c” may be understood as referring to only a, only b, only c, two of a and b, two of a and c, two of b and c, or a combination of all of a, b and c.

Embodiments of the disclosure will now be described with reference to accompanying drawings.

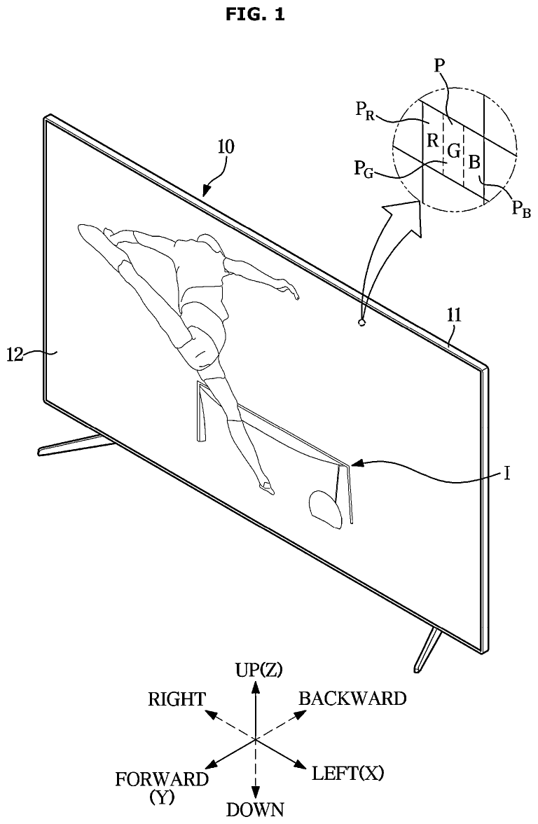

FIG. 1 is a diagram of an example of an exterior of a display apparatus, according to an embodiment.

In the embodiment, a display apparatus 10 is a device that is able to process image signals received from the outside and visually present the processed image. In the following description, it is assumed that the display apparatus 10 is a television (TV), but embodiments of the disclosure are not limited thereto.

For example, the display apparatus 10 may be implemented in various forms such as a monitor, a portable multimedia device, a portable communication device, etc., in addition to a TV. Any device to visually present an image may be the display apparatus 10, and there are no limitations on the type of the device.

The display apparatus 10 may be a large format display (LFD) installed outdoors such as on a rooftop of a building or at a bus stop. In this case, however, the display apparatus 10 is not exclusively installed outdoors, but may be installed at any place, even indoors with increased foot traffic (e.g., at subway stations, shopping malls, theaters, offices, stores, etc.).

The display apparatus 10 may receive content including video and audio signals from various content sources and output video and audio corresponding to the video and audio signals. For example, the display apparatus 10 may receive content data through a broadcast receiving antenna or a cable, receive content data from a content reproducing device, or receive content data from a content providing server of a content provider.

As shown in FIG. 1, the display apparatus 10 may include a main body 11 and a screen 12 for displaying an image I.

The main body 11 forms the exterior of the display apparatus 10, and components for the display apparatus 10 to display the image I or perform many different functions may be included in the main body 11. Although the main body 11 of FIG. 1 is shaped like a flat plate, it is not limited thereto. For example, the main body 11 may have the form of a curved plane.

The screen 12 may be formed on the front of the main body 11 for displaying the image I. For example, the screen 12 may display still images or moving images. The screen 12 may also display two-dimensional (2D) plane images, or three dimensional (3D) stereographic images using parallax of both eyes of the user.

The screen 12 may include, for example, a self-luminous panel (e.g., a light emitting diode (LED) panel or an organic LED (OLED) panel) capable of emitting light at first hand, or a non-luminous panel (e.g., a liquid crystal panel) capable of passing or blocking light emitted from, for example, a light source device (e.g., a backlight unit).

A plurality of pixels P are formed on the screen 12, and the image I displayed on the screen 12 may be implemented by the light emitted by each of the plurality of pixels P. For example, the light emitted by the plurality of pixels P may be combined to form the image I formed on the screen 12.

The plurality of pixels P may emit light in various colors and brightnesses. Each of the plurality of pixels P may include subpixels P_{R}, P_{G} and P_{b} to emit different colors of light.

The subpixels P_{R}, P_{G}, and P_{B} may include a red subpixel P_{R} to emit red light, a green subpixel P_{G} to emit green light, and blue subpixel P_{B} to emit blue light.

For example, the red light may represent light having wavelengths in the range of about 620 nm to 750 nm. The green light may have wavelengths in the range of about 495 nm to 570 nm. The blue light may have wavelengths in the range of about 450 nm to 495 nm.

By combinations of the red light of the red subpixel P_{R}, the green light of the green subpixel P_{G}, and the blue light of the blue subpixel P_{B}, each of the pixels P may emit various brightnesses and colors of light.

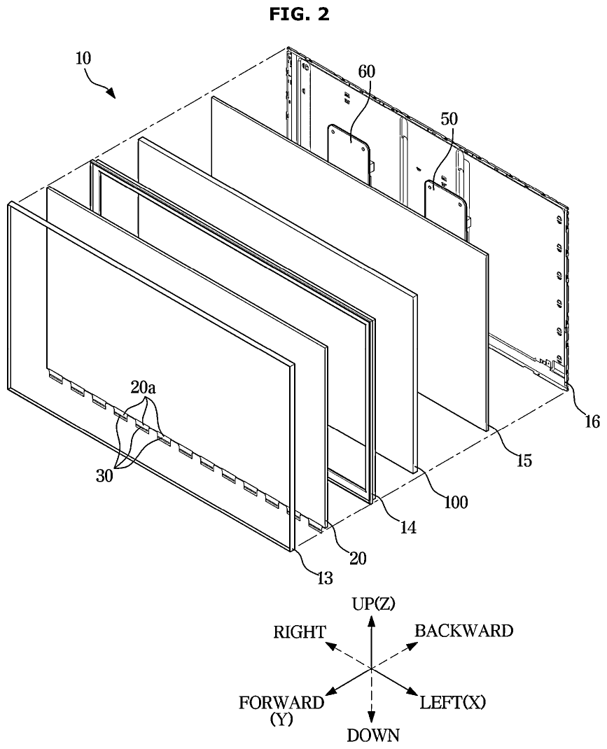

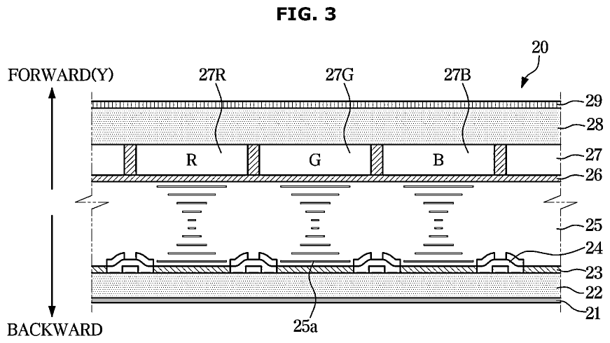

FIG. 2 is a diagram of an example of a structure of a display apparatus, according to an embodiment. FIG. 3 is a cross-sectional view of an example of a liquid crystal panel included in a display apparatus, according to an embodiment. The display apparatus 10 as illustrated herein is a non-luminous display apparatus including a liquid crystal panel and a backlight unit.

As shown in FIG. 2, the main body 11 may contain many different components to create the image I to be displayed on the screen 12.

For example, the main body 11 may be equipped with the backlight unit 100, which is a surface light source, a liquid crystal panel 20 for blocking or passing the light emitted from the backlight unit 100, a control assembly 50 for controlling operations of the backlight unit 100 and the liquid crystal panel 20, and a power assembly 60 for supplying power to the backlight unit 100 and the liquid crystal panel 20.

The main body 11 may include a bezel 13, a frame middle mold 14, a bottom chassis 15, and a rear cover 16 to support the liquid crystal panel 20, the backlight unit 100, the control assembly 50, and the power assembly 60.

The backlight unit 100 may include point light sources for emitting monochromatic light or white light. The backlight unit 100 may refract, reflect, and diffuse the light emitted from the point light sources to convert the light to uniform surface light. In this way, the backlight unit 100 may emit the uniform surface light in a forward direction by refracting, reflecting and diffusing the light emitted from the point light sources. The backlight unit 100 will now be described in more detail.

The liquid crystal panel 20 is arranged in front of the backlight unit 100 for blocking or passing the light emitted from the backlight unit 100 to produce the image I.

The front surface of the liquid crystal panel 20 may form the screen 12 of the aforementioned display apparatus 10, and the liquid crystal panel 20 may be partitioned with the plurality of pixels P. The plurality of pixels P of the liquid crystal panel 20 may each separately block or pass the light from the backlight unit 100, and the light having passed the plurality of pixels P forms the image I to be displayed on the screen 12. The plurality of pixels P may be arranged in the form of a 2D matrix.

Referring to FIG. 3, the liquid crystal panel 20 may include a first polarizer film 21, a first transparent substrate 22, a pixel electrode 23, a thin film transistor 24, a liquid crystal layer 25, a common electrode 26, a color filter 27, a second transparent substrate 28, and a second polarizer film 29.

The first transparent substrate 22 and the second transparent substrate 28 may support the pixel electrode 23, the thin film transistor 24, the liquid crystal layer 25, the common electrode 26, and the color filter 27. The first and second transparent substrates 22 and 28 may be formed of tempered glass or transparent resin.

The first polarizer film 21 and the second polarizer film 29 are arranged on outer sides of the first and second transparent substrates 22 and 28. The first and second polarizer films 21 and 29 may each pass particularly polarized light while blocking the other polarized light.

For example, the first polarizer film 21 may pass polarized light of a first direction while blocking the other polarized light. Furthermore, the second polarizer film 29 may pass polarized light of a second direction while blocking the other polarized light. The first and second directions may be perpendicular to each other. As a result, the polarized light that has passed the first polarizer film 21 may not pass the second polarizer film 29.

The color filter 27 may be arranged on the inner side of the second transparent substrate 28. The color filter 27 may include a red color filter 27R for passing red light, a green color filter 27G for passing green light, and a blue color filter 27B for passing blue light.

The red, green, and blue color filters 27R, 27G, and 27B may be arranged side by side. An area in which the color filter 27 is formed may correspond to the pixel P as described above. An area where the red color filter 27R is formed may correspond to the red subpixel P_{R}, an area where the green color filter 27G is formed may correspond to the green subpixel P_{G}, an area where the blue color filter 27B is formed may correspond to the blue subpixel P_{B}.

The pixel electrode 23 may be arranged on the inner side of the first transparent substrate 22, and the common electrode 26 may be arranged on the inner side of the second transparent substrate 28. The pixel electrode 23 and the common electrode 26 are formed of an electrically conductive metal material, and may produce an electric field to change the layout of liquid crystal molecules that form the liquid crystal layer 25.

The thin film transistor 24 may be arranged on the inner side of the first transparent substrate 22. The thin film transistor 24 may pass or block the current flowing in the pixel electrode 23. For example, depending on whether the thin film transistor 24 is turned on (closed) or turned off (opened), an electric field may be formed or removed from between the pixel electrode 23 and the common electrode 26.

The liquid crystal layer 25 may be formed between the pixel electrode 23 and the common electrode 26 and filled with liquid crystal molecules 25a. The liquid crystals are in an intermediate state between solid (crystal) and fluid. The liquid crystals reveal an optical property according to a change in electric field. For example, the liquid crystal may have varying directions of arrangement of molecules that form the liquid crystal, according to a change in electric field. The optical property of the liquid crystal layer 25 may be changed according to whether there is an electric field passing through the liquid crystal layer 25.

Referring to FIG. 2, a cable 20a for transmitting image data to the liquid crystal panel 20 and a display driver integrated circuit (DDI) 30 (hereinafter, referred to as a ‘panel driver’) for processing digital image data to output an analog image signal may be provided on one side of the liquid crystal panel 20.

The cable 20a may electrically connect the panel driver 30 to the control assembly 50 and the power assembly 60. The cable 20a may also electrically connect the panel driver 30 to the liquid crystal panel 20. The cable 20a may include a flexible flat cable or a film cable, which is bendable.

The panel driver 30 may receive image data from the control assembly 50 and power from the power assembly 60 through the cable 20a. The panel driver 30 may also provide image data and a driving current to the liquid crystal panel 20 through the cable 20a.

The cable 20a and the panel driver 30 may be integrally formed. For example, the cable 20a and the panel driver 30 may be implemented as a chip on film (COF) or a tape carrier package (TCP). In other words, the panel driver 30 may be arranged on the cable 20a. It is not, however, limited thereto, and the panel driver 30 may be arranged on the liquid crystal panel 20.

The control assembly 50 may include a control circuit for controlling operations of the liquid crystal panel 20 and the backlight unit 100. The control circuit may process image data received from an external content source, transmit image data to the liquid crystal panel 20, and transmit dimming data to the backlight unit 100. The control assembly 50 may include at least one memory for storing a program to perform the operations, and at least one processor for executing the stored program.

The power assembly 60 may supply power to the liquid crystal panel 20 and the backlight unit 100. The liquid crystal panel 20 may use the power supplied to block or pass the light emitted from the backlight unit 100. The backlight unit 100 may emit light by using the power supplied.

The control assembly 50 and the power assembly 60 may be implemented with printed circuit boards (PCBs) and various circuits mounted on the PCBs. For example, the control assembly 50 may include a control circuit board on which the processor 91 and the memory 92 are mounted. The power assembly 60 may include a power circuit board on which components such as a capacitor, a coil, a resistor and a processor are mounted.

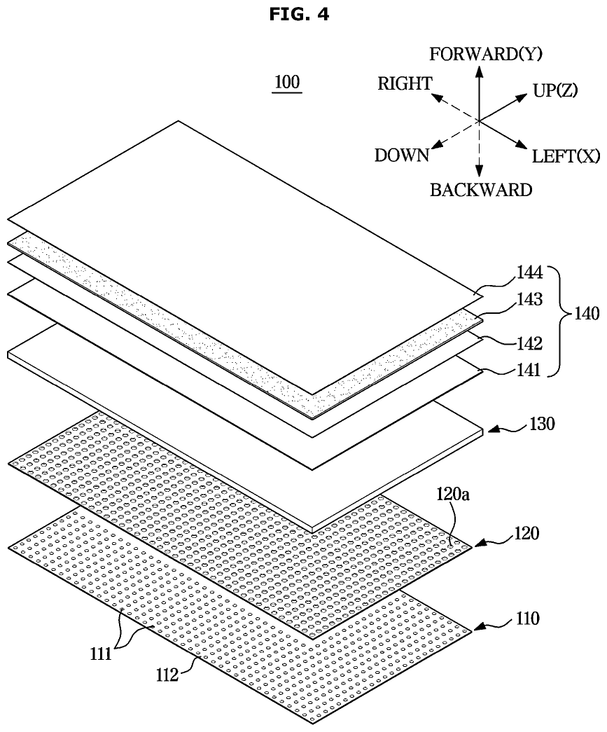

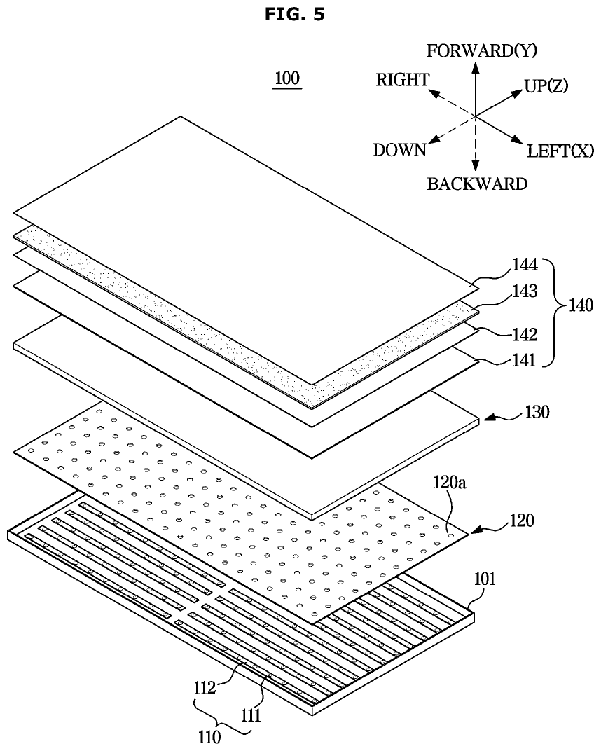

FIGS. 4 and 5 are diagrams of a backlight unit, according to an embodiment.

Referring to FIG. 4, the backlight unit 100 may include a light source module 110, a reflection sheet 120, a diffuser plate 130, and an optical sheet 140 for enhancing brightness of output light.

In an embodiment, the backlight unit 100 may be implemented as a direct type backlight unit having the light source module 110 arranged in the back of the display apparatus 10. Hence, the diffuser plate 130 and the optical sheet 140 may be arranged in front of the light source module 110.

The light source module 110 may include a plurality of light sources 111 for emitting light, and a substrate 112 for supporting/fixing the plurality of light sources 111. The substrate 112 may be formed of a synthetic resin, tapered glass or a PCB with conductive power supply lines formed therein to supply power to the light sources 111.

The reflection sheet 120 may reflect light emitted from the plurality of light sources 111 to a forward direction or to a nearly forward direction.

For example, a plurality of through holes 120a are formed on the reflection sheet 120 at positions respectively matching the plurality of light sources 111 of the light source module 110. The light sources 111 of the light source module 110 may pass through the through holes 120a and protrude forward from the reflection sheet 120, thereby emitting light from the front of the reflection sheet 120. Although the reflection sheet 120 is located in front of the light source module 110 in the exploded perspective view of FIG. 4, it may be understood that the reflection sheet 120 is located behind the plurality of light sources 111 after the backlight unit 100 is assembled.

The reflection sheet 120 may reflect light emitted rearward from the plurality of light sources 111 toward the diffuser plate 130.

The diffuser plate 130 may be arranged in front of the light source module 110 and the reflection sheet 120. The diffuser plate 130 is able to uniformly diffuse the light emitted from the light sources 111 of the light source module 110.

The optical sheet 140 may include various sheets to improve brightness and uniformity in brightness. For example, the optical sheet 140 may include a diffuser sheet 141, a first prism sheet 142, a second prism sheet 143, a reflective polarizer sheet 144, etc.

The diffuser sheet 141 diffuses light for uniformity of brightness. Light emitted from the light sources 111 may be diffused by the diffuser plate 130 and may be further diffused by the diffuser sheet 141 included in the optical sheet 140.

The first and second prism sheets 142 and 143 may concentrate the light diffused by the diffuser sheet 141, thereby increasing brightness. The first and second prism sheets 142 and 143 may have triangular prism patterns, which may be arranged next to each other to form a plurality of bands.

The reflective polarizer film 144 is a type of polarizer film, which may transmit a portion of the incident light while reflecting the other portions to improve brightness. For example, the reflective polarizer sheet 144 may pass light polarized in the same direction as a predetermined polarization direction of the reflective polarizer sheet 144 and reflect light polarized in a different direction than the predetermined polarization direction.

Furthermore, the light reflected by the reflective polarizer film 144 may be recycled inside the backlight unit 100, and this recycling of light may improve brightness of the display apparatus 10.

However, the optical sheet 140 is not necessarily limited to the structure shown in FIG. 4, but it is also possible that some of the sheets as shown in FIG. 4 are omitted or other sheets that are not shown in FIG. 4 are further included.

FIG. 4 shows a case that the light source module 110 is implemented in a flat plate type. Specifically, according to the illustration of FIG. 4, the substrate 112 may be implemented in the flat plate type and the plurality of light sources 111 may be mounted on the substrate 112 and arranged in a 2D matrix.

The plurality of light sources 111 may be arranged on the substrate 112 at preset intervals such that light may be emitted at uniform brightness. Specifically, the plurality of light sources 111 may be arranged such that a light source is equidistant from its neighboring light sources.

For example, as shown in FIG. 4, the plurality of light sources may be arranged to form almost a square with neighboring 4 light sources. Furthermore, a light source is located to be adjacent to four other light sources, and the distances between the light source and the four neighboring light sources may be almost the same or the same.

Alternatively, the plurality of light sources may be arranged such that neighboring three light sources form almost a triangle. In this case, one light source may be arranged to be adjacent to six other light sources. The distances between the one light source and the neighboring six light sources are almost the same or the same.

The layout of the plurality of light sources 111 is not, however, limited thereto, and there is no limit on the layout of the plurality of light sources 111 as long as the light sources may emit light with uniform brightness.

In another example, as shown in FIG. 5, the light source module 110 may be implemented in a bar type. In this case, the substrate 112 may be implemented in the bar type, and the plurality of light sources 111 may be mounted on the substrate 112. Likewise, the plurality of light sources 111 may be arranged in preset arrangement to emit light with uniform brightness.

For example, the plurality of light sources 111 may be arranged such that a light source is equidistant from its neighboring light sources. The plurality of light sources 111 may be arranged equidistantly, in zigzags, or in the form of a 2D matrix.

In the case that the light source module 110 is implemented in the bar type, a plurality of substrates 112 on which the light sources 111 are mounted may be fixed to a bottom chassis 101. In this case, the plurality of substrates 112 may be fixed to the bottom chassis 101 at preset intervals.

When the light source module 110 is implemented in the flat plane type or the bar type, the light source 111 may employ a device capable of emitting monochromatic light (light having a wavelength in a particular range or light having a peak wavelength, e.g., blue light) or white light (light having a plurality of peak wavelengths, e.g., a mixture of red light, green light, and blue light) to various directions when powered. For example, the light source 111 may include a LED.

There are regions where the light source 111 is arranged and where there is no light source 111 arranged, and the region where no light source 111 is arranged is brightly displayed on the screen 12 and the region where the light source 111 is arranged is darkly displayed on the screen 12. That is, depending on the layout of the light source 111, a bright region and a dark region are mixed on the screen 12, which hinders uniformity of image quality.

Hence, the backlight unit 100 and the display apparatus 10 including the same according to an embodiment may enhance uniformity of image quality by adjusting gloss of the diffuser plate 130 included in the backlight unit 100. A detailed structure for implementing this will now be described.

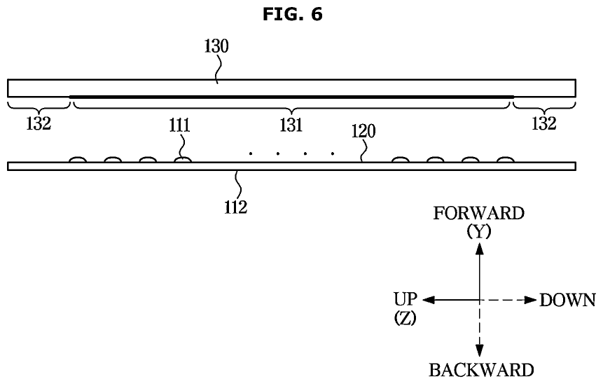

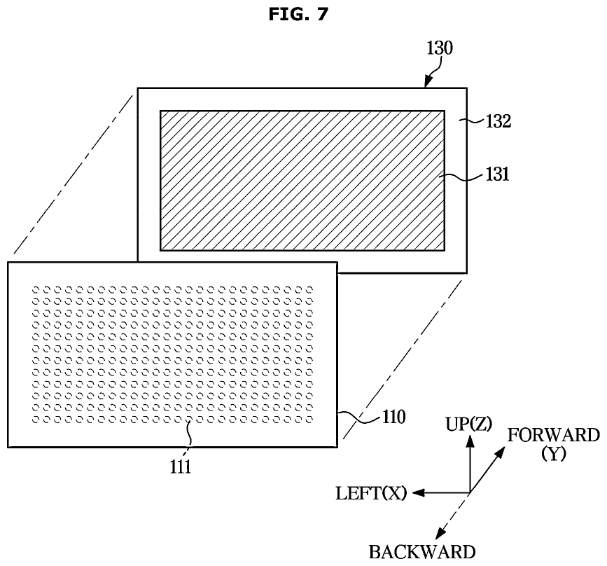

FIG. 6 is a cross-sectional view of gloss of a diffuser plate depending on the position of a light source in a backlight unit, according to an embodiment. FIG. 7 is a diagram of gloss of a diffuser plate depending on the position of a light source in a backlight unit, according to an embodiment.

Referring to FIGS. 6 and 7, the diffuser plate 130 of the backlight unit 100 according to an embodiment may have rear surface gloss that may be adjusted depending on the positions of the plurality of light sources 111 arranged in the light source module 110.

For example, the rear surface of the diffuser plate 130 may be classified into at least two regions 131 and 132 depending on the distances to the plurality of light sources 111, and the at least two regions 131 and 132 may have different gloss.

Of the at least two regions, a region having a relatively short distance to the plurality of light sources 111 may be the first region 131. Of the at least two regions, a region having a relatively long distance to the plurality of light sources 111 may be the second region 132.

The first region 131 may be a portion facing the plurality of light sources 111 or an area including the portion facing the plurality of light sources 111. The second region 132 may be an edge area enclosing the first region 131.

A border between the first region 131 and the second region 132 may be defined by outermost light sources 111 among the plurality of light sources 111.

Although FIGS. 6 and 7 illustrate a case that the plurality of light sources 111 are mounted on the substrate 112 of a flat plate form, aspects of the first region 131 and the second region 132 may be equally applied to a case that the plurality of light sources 111 are mounted on the substrate 112 of a bar type, as shown in FIG. 5.

The first region 131 is an area having a large amount of incident light because of being near to the plurality of light sources 111 (i.e., an area corresponding to a bright portion). On the other hand, the second region 132 is an area having a small amount of incident light because of being distant from the plurality of light sources 111 (i.e., an area corresponding to a dark portion).

In the backlight unit 100 according to an embodiment, first gloss indicating the gloss of the first region 131 may have a smaller value than second gloss indicating the gloss of the second region 132. That is, the second gloss may be adjusted to be higher than the first gloss.

For example, the first gloss may be selected from a range of 5 to 10 gloss units (GU), and the second gloss may be selected from a range of 20 to 30 GU. According to a standard to classify the gloss, the first gloss may correspond to low gloss and the second gloss may correspond to medium gloss.

By adjusting the first gloss of the first region 131 corresponding to the bright portion to be low, intensity of light may be dispersed and lens mura may be relieved. The lens mura is a phenomenon of a lens, which protects the light source 111, being visually perceived as the distance between the light source 111 and components in the front of the light source 111 decreases (i.e., due to the design of display apparatuses resulting in slimmer overall products). As the lens mura phenomenon arises intensely in bright conditions, the backlight unit 100 according to an embodiment may adjust the first gloss of the first region 131 corresponding to the bright portion to be relatively low, thereby relieving the phenomenon of visual perception of the lens.

Furthermore, light dispersion may be facilitated by adjusting the second gloss of the second region 132 corresponding to the dark portion to be relatively high. In other words, non-uniformity of image quality due to the brightness difference between the first region 131 corresponding to the bright portion and the second region 132 corresponding to the dark portion may be solved.

Adjustment of the gloss of the diffuser plate 130 may be performed by various methods. For example, the first region 131 and the second region 132 of the diffuser plate 130 may be formed with different roughness using a roller. Specifically, the gloss of the first region 131 may be implemented to be lower than the gloss of the second region 132 by forming the roughness of the first region 131 to be relatively high and the second region 132 to be relatively low.

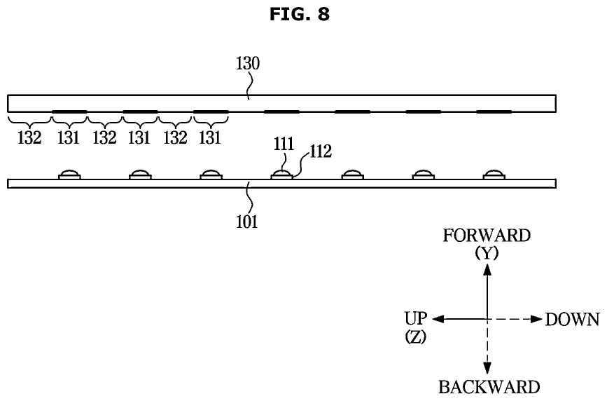

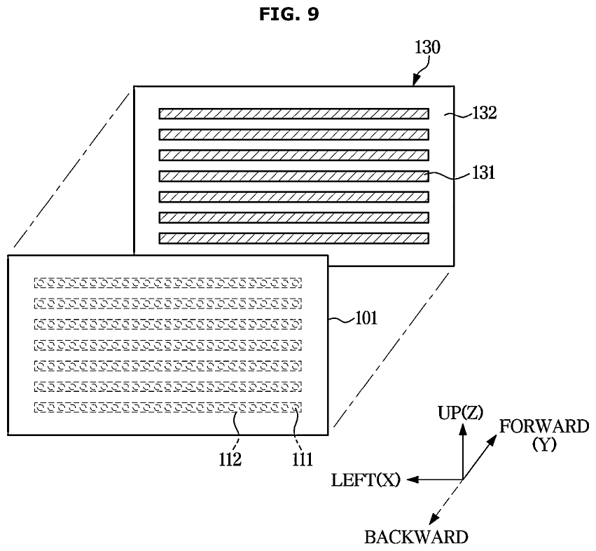

FIG. 8 is a cross-sectional view of gloss of a diffuser plate depending on the position of a light source in a backlight unit, according to an embodiment. FIG. 9 is a diagram of gloss of a diffuser plate depending on the position of a light source in a backlight unit, according to an embodiment.

As shown in FIGS. 8 and 9, the plurality of light sources 111 may be mounted on a bar shaped substrate 112, and the plurality of substrates 112 with the plurality of light sources 111 mounted thereon may be arranged in one direction as shown in FIG. 9. Accordingly, the plurality of light sources 111 may be arranged in 2D.

FIG. 8 illustrates the backlight unit 100 viewed from the YZ plane and FIG. 9 illustrates the backlight unit 100 viewed from the XZ plane.

In this example, the diffuser plate 130 may have the rear surface gloss that may be adjusted depending on the position of the plurality of light sources 111 arranged in the light source module 110.

For example, the rear surface of the diffuser plate 130 may be classified into (e.g., divided into, separated into, physically partitioned, etc.) at least two regions 131 and 132 depending on the distances to the plurality of light sources 111, and the at least two regions 131 and 132 may have different gloss.

Of the at least two regions, a region having a relatively short distance to the plurality of light sources 111 may be the first region 131. Of the at least two regions, a region having a relatively long distance to the plurality of light sources 111 may be the second region 132.

Referring to FIGS. 8 and 9, the first region 131 may be a portion facing the plurality of light sources 111 or an area including the portion facing the plurality of light sources 111. The first region 131 may include a plurality of sub-regions 131′ corresponding to the plurality of substrates 112, respectively. The plurality of sub-regions 131′ may have matching shapes to the plurality of substrates 112, respectively.

The second region 132 may correspond to an area of the diffuser plate 130 not including the first region 131 and/or the plurality of sub-regions 131′. A border between the first region 131 and the second region 132 may be defined according to the shape and size of the plurality of substrates 112.

The first region 131 or the plurality of sub-regions 131′ are areas having a large amount of incident light because of being near to the plurality of light sources 111 (i.e., an area corresponding to a bright portion). On the other hand, the second region 132 is an area having a small amount of incident light because of being distant from the plurality of light sources 111 (i.e., an area corresponding to a dark portion).

By adjusting the first gloss of the first region 131 corresponding to the bright portion to be relatively low, intensity of light may be dispersed and lens mura may be relieved. Furthermore, light dispersion may be facilitated by adjusting the second gloss of the second region 132 corresponding to the dark portion to be relatively high.

An experiment for evaluating performance of the backlight unit 100 according to an embodiment was performed. Results of the experiment will now be described.

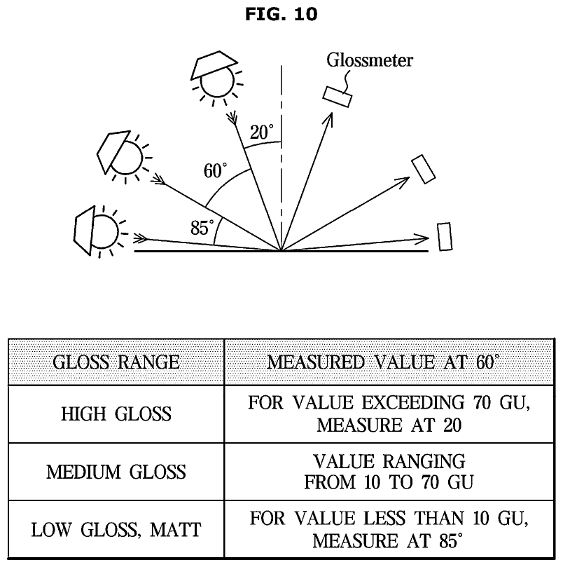

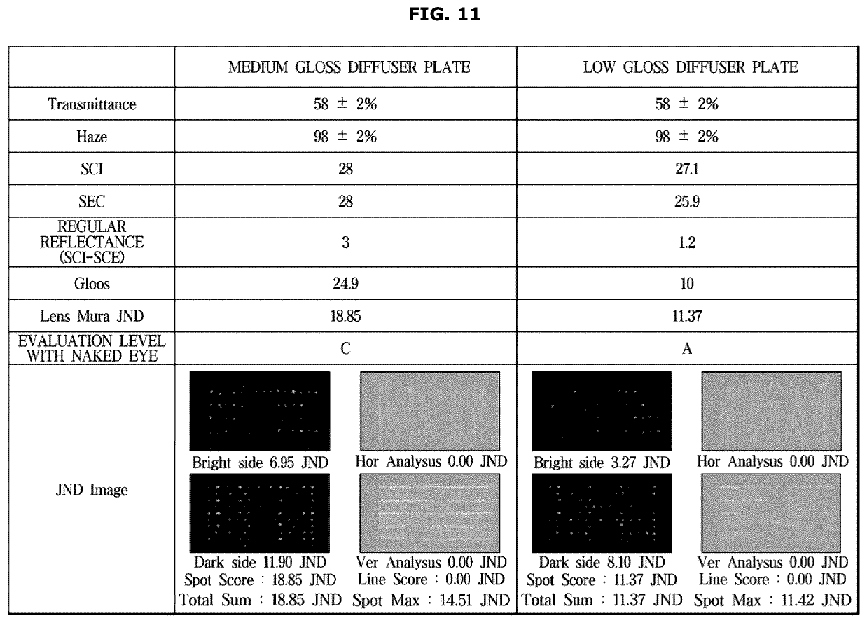

FIG. 10 is a table representing references of gloss applied to experiments of a backlight unit, according to an embodiment. FIG. 11 is a table representing results of experiments on a diffuser plate of a backlight unit, according to an embodiment.

The gloss may be measured by a glossmeter. For example, the glossmeter may measure the gloss by forcing the light to be incident onto a target object or a horizontal plane where the target object is placed at 20, 60 and 85 degrees from the vertical axis.

Referring to FIG. 10, the gloss may all be measured at the angle of 60 degrees for the first time, and when the measured value of the gloss exceeds 70 GU, the gloss may be finally remeasured at the angle of 20 degrees.

Furthermore, when a measured value of the gloss is in a range of 10 to 70 GU, it may be classified as medium gloss, and when a measured value of the gloss is less than 10 GU, the final gloss may be remeasured at the angle of 85 degrees.

For the experiment, a diffuser plate having the medium glass and a diffuser plate having low gloss were prepared. As shown in FIG. 11, the gloss of the diffuser plate having the medium gloss may be measured as 24.9, and the gloss of the diffuser plate having the low gloss may be measured as 10.

Furthermore, for both the diffuser plate having the medium gloss and the diffuser plate having the low gloss, transmittance was measured as 58±2% and haze was measured as 98±2%.

Reflectance was measured for both Specular Component Included (SCI) and Specular Component Excluded (SCE), and the SCI of the diffuser plate having the medium gloss was measured as 28 and the SCE of the diffuser plate having the low gloss was measured as 27.1.

The SCE of the diffuser plate having the medium gloss was measured as 25 and the SCI of the diffuser plate having the low gloss was measured as 25.9. That is, the diffuser plate having the medium glass and the diffuser plate having low gloss have similar reflectance.

In other words, the two diffuser plates used in the experiment were adjusted to have different gloss of 24.9 and 10, respectively, while having similar reflectance.

The lens mura of the two diffuser plates 130 was measured on a just noticeable difference (JND) index basis. As a result, the lens mura of the diffuser plate having the medium gloss was measured as 18.85 JND, and the lens mura of the diffuser plate having the low gloss was measured as 11.37 JND.

Furthermore, when images of the diffuser plate having the medium gloss and the diffuser plate having the low gloss as shown in FIG. 11 are compared with each other, it may be seen that the diffuser plate having the medium gloss has higher lens visibility.

Hence, based on the results of the experiment, it may be seen that the backlight unit 100 according to an embodiment has a relieved lens mura phenomenon by adjusting the gloss of the first region 131 to have 5 to 10 GU lower than that of the second region 132.

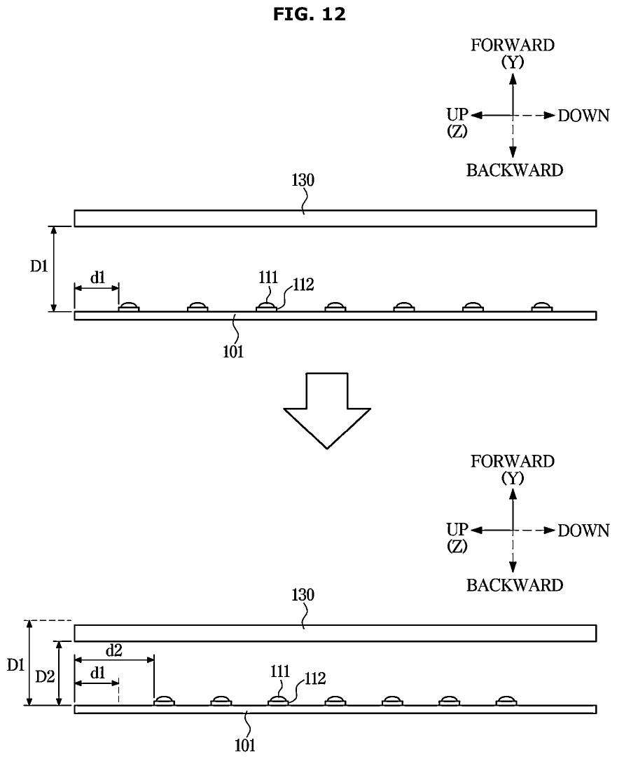

FIG. 12 is a cross-sectional view of a backlight unit, according to an embodiment.

FIG. 12 illustrates the backlight unit 100 viewed from the YZ plane according to an embodiment. To implement a slim display apparatus by employing the direct type backlight unit, panel depth may be reduced.

In an embodiment, the backlight unit 100 may relieve the lens mura phenomenon by adjusting gloss of the rear surface of the diffuser plate 130 in front of the light source module 110, such that, as shown in FIG. 12, the display apparatus 10 may be manufactured to be slim by reducing distance D1 between the diffuser plate 130 and the light source module 110 to D2.

Furthermore, in an embodiment, the backlight unit 100 has low gloss of the first region 131 corresponding to a bright portion of the diffuser plate 130 and high gloss of the second region 132 corresponding to a dark portion, thereby efficiently dispersing the light. Accordingly, same or similar performance may be maintained even with a less number of the light sources 111, so the light sources 111 may be reduced in number and moved inward. In other words, the distance between the outermost light source and an end of the bottom chassis 101 may be increased to d2 from d1 in the direction Z.

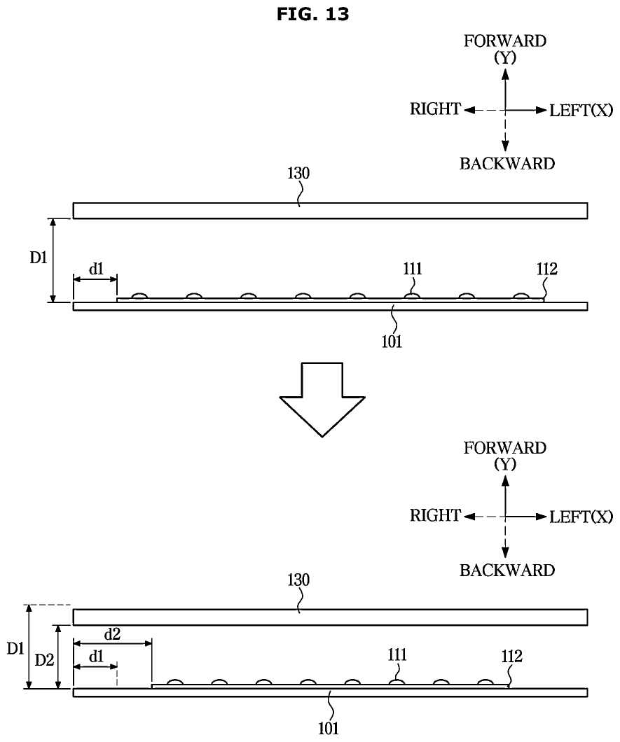

FIG. 13 is a cross-sectional view of a backlight unit, according to an embodiment.

FIG. 13 illustrates the backlight unit 100 viewed from the XY plane according to an embodiment. Referring to FIG. 13, the light sources 111 may be moved inward even in the direction of X by reducing the length of the bar shaped substrate 112 and the number of the light sources 111 mounted on the substrate 112.

According to the backlight and the display apparatus including the same having thus far been described, uniformity of image quality may be enhanced by adjusting gloss of the diffuser plate 130 included in the backlight unit 100.

Specifically, by adjusting the first gloss of the first region 131 corresponding to the bright portion to be relatively low, an intensity of light may be dispersed and lens mura may be relieved. The lens mura is a phenomenon of a lens, which protects the light source 111, being visually perceived as the distance between the light source 111 and components in the front of the light source 111 decreases (i.e., due to the design of display apparatuses resulting in slimmer overall products). As the lens mura phenomenon arises intensely in bright conditions, the backlight unit 100 according to an embodiment may have the first gloss of the first region 131 corresponding to the bright portion adjusted to be relatively low, thereby solving the phenomenon of visual perception of the lens.

Furthermore, light dispersion may be facilitated by adjusting the second gloss of the second region 132 corresponding to the dark portion to be relatively high. In other words, non-uniformity of image quality due to the brightness difference between the first region 131 corresponding to the bright portion and the second region 132 corresponding to the dark portion may be solved.

The embodiments of the disclosure disclosed in the specification and the drawings provide merely specific examples to easily describe technical content according to the embodiments of the disclosure and help the understanding of the embodiments of the disclosure, not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. A backlight unit comprising:
a light source module comprising a plurality of light sources;
a reflection sheet configured to reflect light emitted rearward from the plurality of light sources; and
a diffuser plate provided in front of the light source module,
wherein the diffuser plate comprises at least two regions having different distances to the plurality of light sources,
wherein a first gloss of a first region of the at least two regions and a second gloss of a second region of the at least two regions are different from each other.

2. The backlight unit of claim 1, wherein the first region is at a first distance from the plurality of light sources,
wherein the second region is at a second distance to the plurality of light sources that is greater than the first distance, and
wherein the second gloss of the second region is higher than the first gloss of the first region.

3. The backlight unit of claim 2, wherein the first region comprises an area on the diffuser plate facing the plurality of light sources, and
wherein the second region comprises an edge area on the diffuser plate enclosing the first region.

4. The backlight unit of claim 3, wherein a border between the first region and the second region is determined based on positions of outermost light sources among the plurality of light sources.

5. The backlight unit of claim 2, wherein the light source module further comprises a plurality of substrates having a bar shape, and
wherein the plurality of light sources are provided on the plurality of substrates.

6. The backlight unit of claim 5, wherein the first region comprises a plurality of sub-regions in the diffuser plate corresponding to the plurality of substrates, and
wherein the second region comprises an area of the diffuser plate not corresponding to the plurality of sub-regions.

7. The backlight unit of claim 2, wherein the first gloss of the first region is between 5 gloss units (GU) to 10 GU, and
wherein the second gloss of the second region is between 20 GU to 30 GU.

8. The backlight unit of claim 1, wherein the first region has a first roughness that is higher than a second roughness of the second region.

9. The backlight unit of claim 1, wherein a first thickness of the diffuser plate at a first location corresponding of the first region is larger than a second thickness of the diffuser plate at a second location corresponding to the second region.

10. The backlight unit of claim 1, wherein the at least two regions are provided on a rear surface of the diffuser plate.

11. A display apparatus comprising:
a liquid crystal panel; and
a backlight unit provided behind the liquid crystal panel and configured to supply light to the liquid crystal panel,
wherein the backlight unit comprises:
a light source module comprising a plurality of light sources;
a reflection sheet configured to reflect light emitted rearward from the plurality of light sources; and
a diffuser plate provided in front of the light source module,
wherein the diffuser plate comprises at least two regions having different distances to the plurality of light sources,
wherein a first gloss of a first region of the at least two regions and a second gloss of a second region of the at least two regions are different from each other.

12. The display apparatus of claim 11, wherein the first region is at a first distance from the plurality of light sources,
wherein the second region is at a second distance from the plurality of light sources that is greater than the first distance, and
wherein the second gloss of the second region is higher than the first gloss of the first region.

13. The display apparatus of claim 12, wherein the first region comprises an area on the diffuser plate facing the plurality of light sources, and
wherein the second region comprises an edge area on the diffuser plate enclosing the first region.

14. The display apparatus of claim 13, wherein a border between the first region and the second region is determined based on positions of outermost light sources among the plurality of light sources.

15. The display apparatus of claim 12, wherein the light source module further comprises a plurality of substrates having a bar shape, and
wherein the plurality of light sources are provided on the plurality of substrates.

16. The display apparatus of claim 15, wherein the first region comprises a plurality of sub-regions in the diffuser plate corresponding to the plurality of substrates, and
wherein the second region comprises an area of the diffuser plate not corresponding to the plurality of sub-regions.

17. The display apparatus of claim 12, wherein the first gloss of the first region is between 5 gloss units (GU) to 10 GU, and
wherein the second gloss of the second region is between 20 GU to 30 GU.

18. The display apparatus of claim 11, wherein the first region has a first roughness that is higher than a second roughness of the second region.

19. The display apparatus of claim 11, wherein a first thickness of the diffuser plate at a first location corresponding to the first region is larger than a second thickness of the diffuser plate at a second location corresponding to the second region.

20. The display apparatus of claim 11, wherein the at least two regions are provided on a rear surface of the diffuser plate.
